(19) United States
(12) Patent Application Publication
(10) Pub. No.: US 2015/0324370 A1
(43) Pub. Date: Nov. 12, 2015

(54) MULTIMEDIA PORTFOLIO MANAGEMENT SYSTEM AND METHOD

(71) Applicant: Laura Penrod Stock, Leesburg, GA (US)

(72) Inventor: Laura Penrod Stock, Leesburg, GA (US)

(21) Appl. No.: 14/709,245

(22) Filed: May 11, 2015

Related U.S. Application Data
(60) Provisional application No. 61/991,577, filed on May 11, 2014.

(51) Int. Cl. G06F 17/30

(52) U.S. Cl. CPC G06F 17/30064; G06F 17/30203; G06F 17/302; G06F 17/30176; G06F 17/30106; G06F 17/3005

(57) ABSTRACT

A system and a method for creating, publishing, and managing a plurality of multimedia portfolios, each portfolio associated with a user of the system, is provided. Computer systems are programmed to allow a plurality of users to each create, publish, and manage multimedia portfolios. The process of working with multimedia portfolios is streamlined by utilizing a single web-based software application that can accomplish all of the tasks necessary to manage the portfolios. In addition, a software wizard is provided that will easily and conveniently guide users through certain tasks related to the management of multimedia portfolios. Users of the system also have the ability to control third party access to all or parts of a portfolio.

### CROSS REFERENCES

This application claims the benefit of U.S. Provisional Application No. 61/991,577, filed on May 11, 2014, which application is incorporated herein by reference.

### FIELD OF THE INVENTION

The present invention refers generally to a system and a method for allowing a plurality of users to create and manage multimedia portfolios.

### BACKGROUND

There are currently many software applications available for generating multimedia portfolios. However, most of the applications currently available are overly complex and not user-friendly. For instance, many of the current applications require the user to sign up for multiple products, such as Dropbox or Google, in addition to the portfolio software application itself. In addition, some applications are limited in the types of multimedia files that can be used in the portfolio. Currently known portfolio applications also do not allow a user to automatically label and store digital image or video files for use in the portfolio as the image or video is captured by the user, thus making later retrieval of image or video files inconvenient and inefficient.

In addition, other known portfolio applications typically require the user to enter an email address. Although most people now have email addresses, this can be a problem for younger children, who often do not have email addresses. Furthermore, current applications are not always completely secure and private.

Therefore, a need exists for a digital library management system and method that will provide users with a means of easily and conveniently creating, organizing, and publishing multimedia portfolios.

### SUMMARY

The present invention relates to a system and a method for creating and managing multimedia portfolios comprising a plurality of multimedia files. The multimedia files may include, but are not limited to, word processor files, spreadsheet files, digital image files, digital music or other sound files, and digital video files.

In accordance with an implementation of the invention, computer applications are programmed to provide a streamlined process of creating, organizing, and publishing multimedia portfolios. The problems with the prior art that are outlined above are solved in one aspect by using a single web-based software application that is convenient and user-friendly. Thus, a user will be able to upload multimedia files and use those files to create a multimedia portfolio by registering for and using only one software application. In addition, the application is secure, private, and programmed to integrate any type of multimedia file into the portfolio.

Another embodiment of the invention includes a software wizard to guide the user through the process of uploading, labeling, and storing multimedia files. As used herein, a software wizard, also known as a setup assistant, is a user interface that presents a user with a sequence of dialog boxes that lead the user through a series of well-defined steps. Generally, tasks that are complex, infrequently performed, or unfamiliar may be easier to perform using a wizard. When using the wizard, the user is presented with an option to label and choose a location for storing a multimedia file. The wizard solves a problem present in the prior art, particularly with respect to digital image and video files. Typically, when the user first creates digital image or video files he does not have the ability to assign a label to the file at the time the user captures the image or video. Instead, labels for image and video files in the prior art are automatically generated and are not descriptive of the file, thus making later retrieval of such files inconvenient and inefficient for the user. The wizard solves this problem. However, in this embodiment, the wizard is not limited to use with only image or video files. The wizard may be used to label and store any type of multimedia file either at the time the file is created or at any subsequent time.

The users of the software application may be individuals, groups of individuals, or organizations. In a preferred embodiment, the users are students and teachers who use the system to create multimedia portfolios related to the achievements of a student or a class of students. For instance, individual students may use the system to share portfolios with friends or relatives, or as part of a college application or job application. Teachers may create portfolios for their class of students to demonstrate achievements of the class to parents or other individuals associated with the school. In addition, students and teachers may create a multimedia portfolio that may be used as part of a student-led parent-teacher conference. In this context, the multimedia portfolio can be an important tool in providing parents with a complete picture of their child's progress in school.

Another advantage of having a personal multimedia portfolio for individual students is that students who change schools will be able to maintain a portfolio from their old school and continue adding new content after moving to a new school.

In one implementation of the invention, each user will create a user account the first time using the software. Each user will have the option of entering a code instead of an email address. This embodiment is particularly useful in the educational setting as many younger children do not have email addresses. In a preferred embodiment, a code will be associated with a particular teacher who will give out the code to each student in the teacher's class. Beforehand, the teacher will enter a list of all students who will have access to a particular code. When a student first uses the system, the student can enter the code and his name, which will match the name on the list and thereby create an account associated with that student. Thus, an email address is not necessary to use the system.

Although the present invention is preferably used by students and teachers, it is not limited to use by students and teachers and can be adapted to a variety of particular purposes for a variety of other users. For instance, special portfolio templates may be designed for athletes to showcase their athletic abilities and accomplishments by means of a portfolio containing digital images, digital video of athletic performances, and files indicating athletic statistics relating to the user. Other templates may be designed for pet owners to create portfolios of images and records related to their pets, or for individuals to keep a portfolio of personal medical records. Yet other embodiments of the current invention may be utilized for companies and other organizations for storing various information in a portfolio.

### DESCRIPTION OF THE DRAWINGS

These and other features, aspects, and advantages of the present invention will become better understood with regard to the following description, appended claims, and accompanying drawings where:

FIG. 1 is a system diagram illustrating an apparatus and system for managing a plurality of multimedia portfolios by a plurality of users.

FIG. 2 is a system diagram illustrating an apparatus and system for managing a plurality of multimedia portfolios by a plurality of users.

FIG. 3 is a system diagram illustrating an apparatus and system for managing a plurality of multimedia portfolios by a plurality of users.

FIG. 4 illustrates a method of a user creating, publishing, and managing a multimedia portfolio associated with that particular user.

FIG. 5 illustrates a method of a user uploading and storing a multimedia file associated with the user's portfolio via a software wizard.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with or in the context of other particular aspects of the embodiments of the invention, and in the invention generally.

The term “comprises” and grammatical equivalents thereof are used herein to mean that other components, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following detailed description, reference is made to the accompanying drawings that form a part hereof, and in which is shown by way of illustration specific embodiments in which the subject matter can be practiced. These embodiments are described in sufficient detail to enable those skilled in the art to practice them, and it is to be understood that other embodiments can be utilized and that structural, logical, and electrical changes can be made without departing from the scope of the inventive subject matter. Such embodiments of the inventive subject matter can be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense.

The embodiments of the systems and methods described herein may be implemented in hardware or software, or a combination of both. For example, some embodiments may be implemented in computer systems and computer programs, which may be stored on a physical computer-readable medium, executable on programmable computers each comprising at least one processor, a data storage system (including volatile and non-volatile memory and/or storage elements), at least one input device (e.g. a keyboard or mouse), and at least one output device (e.g. a display screen, a network, or a remote server). For example and without limitation, the programmable computers may include personal computers, laptops, netbook computers, personal data assistants (PDA), cell phones, smart phones, smart cameras, gaming devices, and other mobile devices.

In accordance with the present invention, a system and a method for creating and managing electronic portfolios are provided. The portfolio system comprises at least one computer application comprising computer executable code stored on computer-readable medium. The code is executed by a plurality of computing devices, which may include laptops, personal computers, smart phones, or any similar computing devices capable of communicating with a network. The computing devices communicate with at least one server via a communications network. The server also communicates with at least one database, which is used to store user's multimedia computer files for use in a user's portfolio.

The computer application is programmed to provide a streamlined process for creating, organizing, and publishing multimedia portfolios. The application is preferably a single web-based software application that allows a user to create and manage an electronic portfolio viewable on the output of a computing device in communication with the server. The application allows a user to perform a variety of actions. The user can upload multimedia files for use in the user's multimedia portfolio, label multimedia files, create and label folders in which to store the files, select a folder in which to store a file, and create a portfolio using the user's uploaded multimedia files. Additionally, the application allows the user to control access to the user's portfolio by selecting particular viewers who may view the portfolio and also which parts of the portfolio a particular viewer may see.

Another embodiment of the invention includes a software wizard to guide the user through the process of uploading, labeling, and storing multimedia files. As used herein, a software wizard, also known as a setup assistant, is a user interface that presents a user with a sequence of dialog boxes that lead the user through a series of well-defined steps. When using the wizard, the user is presented with an option to label and choose a location for storing a multimedia file.

The users of the software application may be individuals, groups of individuals, or organizations. In a preferred embodiment, the users are students and teachers who use the system to create multimedia portfolios related to the achievements of a student or a class of students. For instance, individual students may use the system to share portfolios with friends or relatives, or as part of a college application or job application. Teachers may create portfolios for their class of students to demonstrate achievements of the class to parents or other individuals associated with the school. In addition, students and teachers may create a multimedia portfolio that may be used as part of a student-led parent-teacher conference. In this context, the multimedia portfolio can be an important tool in providing parents with a complete picture of their child's progress in school.

In one implementation of the invention, each user will create a user account the first time using the software. When first registering for the account, each user will have the option of entering a code instead of an email address. This embodiment is particularly useful in the educational setting as many younger children do not have email addresses. In a preferred embodiment, a code will be associated with a particular teacher who will give out the code to each student in the teacher's class. In yet another embodiment, a code will be associated with a particular organization, or part of an organization. Beforehand, the teacher will enter a list of all students who will have access to a particular code. When a student first uses the system, the student can enter the code and his name, which will match the name on the list and thereby create an account associated with that student. Thus, an email address is not necessary to use the system.

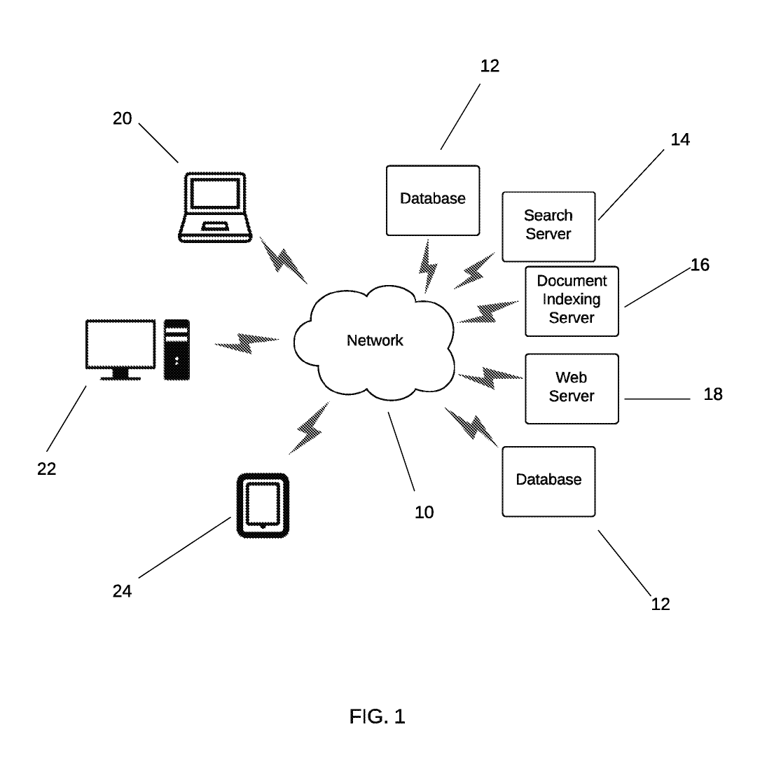

Turning now to the drawings, FIGS. 1-5 illustrate preferred embodiments of the present invention. FIG. 1 is an exemplary diagram of a network 10 in which systems and methods consistent with the principles of the invention may be implemented. The network 10 may include multiple clients 20, 22, 24 connected to multiple servers 14, 16, 18 via a network, which may include one or more networks of any kind, including, but not limited to, a local area network (LAN), a wide area network (WAN), a telephone network, such as the Public Switched Telephone Network (PTSN), an intranet, the Internet, a memory device, another type of network, or a combination of networks. Three clients 20, 22, 24, three servers 14, 16, 18, and two databases 12 have been illustrated as connected to the network for simplicity. In practice, there may be more or fewer clients, servers, and databases.

Clients may include devices of users that access servers. A client may include, for instance, a laptop 20, a personal computer 22, a smart phone 24, or any similar computing device including, but not limited to, a wireless telephone, a personal digital assistant (PDA), a tablet computer, a smart camera, or another type of computation or communication device.

Servers may include devices that access, fetch, aggregate, process, search, provide, and/or maintain documents. Although shown as single components in FIG. 1, each server may, in some implementations, be implemented as multiple computing devices, which potentially may be geographically distributed. One or more search servers 14 may include one or more computing devices designed to implement a search engine, such as a documents/records search engine, general webpage search engine, etc. Search server may, for example, include one or more web servers to receive search queries and/or inputs from clients, search one or more databases in response to the search queries and/or inputs, and provide documents, relevant to the search queries and/or inputs, to clients. In some implementations, the search server 14 may include a web search server that may provide webpages to clients, where a provided webpage may include a reference to a web server at which the desired information is located and other information and/or links. The references, to the web server at which the desired information is located, may be included in a frame and/or text box, or as a link to the desired information/document.

One or more document indexing servers 16 may include one or more computing devices designed to index documents available through the network 10. The document indexing server 16 may access other servers, such as web servers that host content, to index the content. In some implementations, the document indexing server may index documents/records stored by other servers, such as web servers and, connected to the network. Document indexing server may, for example, store and index content, information, and documents relating to a user's stored documents, videos, and images.

One or more web servers 18 may each include web servers that provide webpages to clients. The webpages may be, for example, HTML-based webpages. A web server may host one or more websites. A website, as the term is used herein, may refer to a collection of related webpages. Frequently, a website may be associated with a single domain name, although some website may potentially encompass more than one domain name. The concepts described herein may be applied on a per-website basis. Alternatively, in some implementations, the concepts described herein may be applied on a per-webpage basis.

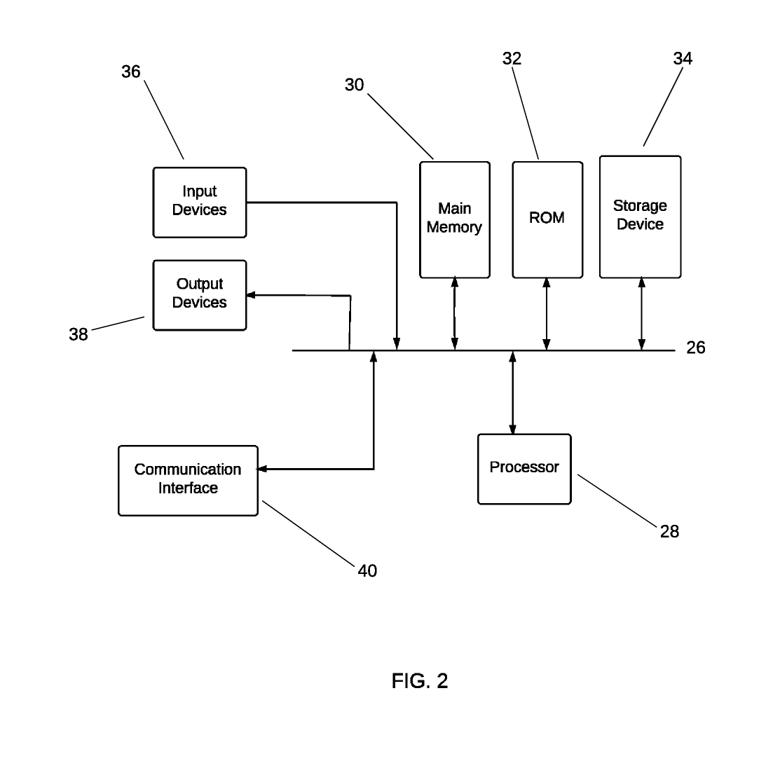

FIG. 2 is an exemplary diagram of a client or server entity (hereinafter called “client/server entity”), which may correspond to one or more of the clients and servers, according to an implementation consistent with the principles of the invention. The client/server entity may include a bus 26, a processor 28, a main memory 30, a read only memory (ROM) 32, a storage device 34, one or more input devices 36, one or more output devices 38, and a communication interface 40. The bus 26 may include one or more conductors that permit communication among the components of the client/server entity.

The processor 28 may include any type of conventional processor or microprocessor that interprets and executes instructions. The main memory 30 may include a random access memory (RAM) or another type of dynamic storage device that stores information and instructions for execution by processor. The ROM 32 may include a conventional ROM device or another type of static storage device that stores static information and instructions for use by processor. The storage device 34 may include a magnetic and/or optical recording medium and its corresponding drive.

Input device(s) 36 may include one or more conventional mechanisms that permit an operator to input information to the client/server entity, such as a keyboard, a mouse, a pen, voice recognition and/or biometric mechanisms, etc. Output device(s) 38 may include one or more conventional mechanisms that output information to the operator, including a display, a printer, a speaker, etc. Communication interface 40 may include any transceiver-like mechanism that enables the client/server entity to communicate with other devices and/or systems. For example, communication interface may include mechanisms for communicating with another device or system via a network, such as the network 10 illustrated in FIG. 1.

As will be described in detail below, the client/server entity, consistent with the principles of the invention, performs certain search-related and verification-related operations. The client/server entity may perform these operations in response to processor 28 executing software instructions contained in a computer-readable medium, such as memory. A computer-readable medium may be defined as one or more physical or logical memory devices and/or carrier waves.

The software instructions may be read into memory from another computer-readable medium, such as a data storage device 34, or from another device via communication interface 40. The software instructions contained in memory causes the processor 28 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

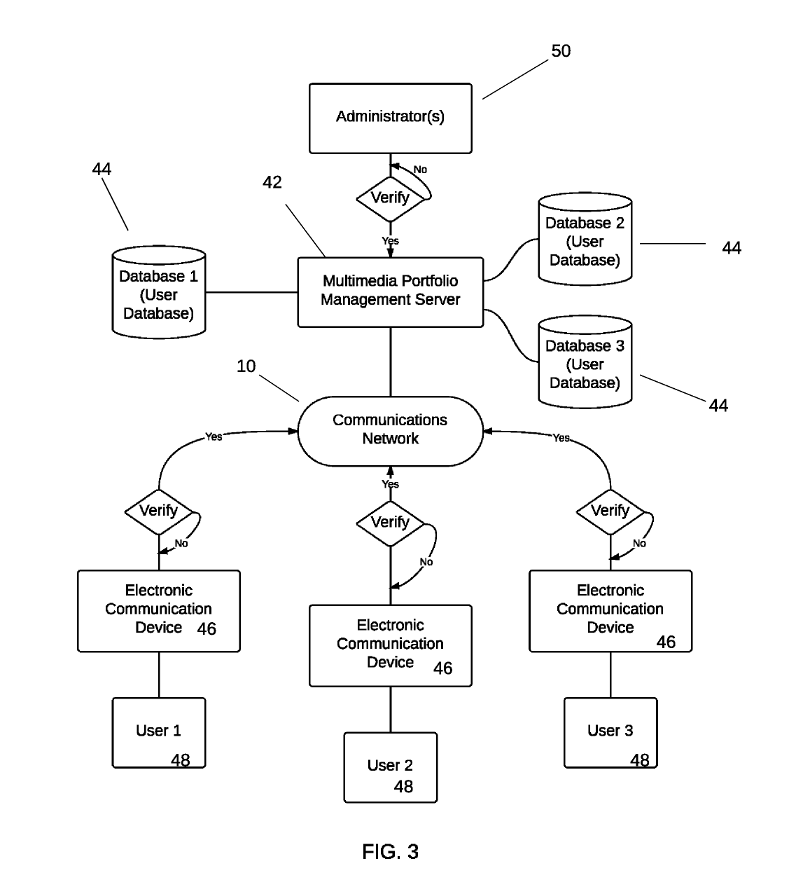

FIGS. 3-5 illustrate flowcharts of exemplary processing for multimedia digital asset management according to an implementation consistent with the principles of the invention. In one implementation, there is provided a system comprising a method of managing a plurality of multimedia files that users of the system may use to create one or more multimedia portfolios associated with each user. The example embodiment provides methods and computer systems programmed to use a software application, method, and apparatus for storing, organizing, publishing, and managing multimedia files associated with each user's multimedia portfolio. In addition, a preferred embodiment provides methods and computer systems for interacting and communicating with the software application, method, and apparatus. The separate method and computer system components making up the present invention are collectively referred to as the “Multimedia Portfolio Management” system, method, and apparatus.

In a preferred embodiment, the software application provides a system and a method for uploading and managing a plurality of multimedia files, creating a portfolio comprising a plurality of the multimedia files, and publishing the multimedia portfolio on a website on the internet. In one implementation, a user uses a web browser to access an admin website, or application. Alternatively, the user may choose not to publish the portfolio on a website but may use the portfolio for offline use. In yet another embodiment, the software application provides a means for communicating with third party software and portfolio management applications.

FIG. 3 illustrates a preferred implementation of an embodiment of the Multimedia Portfolio Management system. In this embodiment, the system comprises a data processor and memory programmed to receive and store digital files of various types. In an example embodiment, the Multimedia Portfolio Management server 42 comprises at least one database 44 containing multimedia files. The one or more databases 44 stores computer files associated with a particular user 48 of the system. The system may comprise a plurality of databases 44, with each database 44 associated with the files of a particular user 48, or one database 44 may be used that tags files associated with specific users 48. Each user 48 has access only to the files associated with that user 48, unless the user shares one or more files with another user of the system.

A user 48 may access multimedia files stored in the one or more databases 44 only after the user's identity has been verified. This verification step may be by password, passcode, or equivalent means. In on implementation, a user 48 logs into an admin web page and enters a unique username and password. If the user 48 is using the software application for the first time, the user will first establish a new user account. The application will prompt the user 48 to input personal information verifying the user's identity. For instance, the application may require the user 48 to enter an email address and password.

In another implementation, the user 48 will have the option of entering a code instead of an email address. This embodiment is particularly useful when the system is used by teachers and students, particularly when the students are younger children who may not have email addresses. In this embodiment, a class code will be associated with a particular teacher who will give out the code to each student in the teacher's class. Beforehand, the teacher will input a list of all students who will have access to a particular code. When a student user 48 first uses the system, the student can enter the code and the student's name, which will match the student's name on the list and thereby create an account associated with that student. Thus, an email address is not necessary to use the system. The student may then use the code to access the student's account at any time.

Once the user's identity has been verified, the user 48 may then access the multimedia files associated with that user via a communications network 10. The network 10 may be a wired or wireless network and may provide access to the database 44 via the internet or an intranet. In a preferred embodiment, the communications network 10 of the present invention is connected to the internet, thus allowing third parties to view users' multimedia portfolios through a website, an application, or equivalent viewing means.

In a preferred embodiment, one or more administrators 50 of the overall Multimedia Portfolio Management system have access to all files stored on all databases 44 upon verification of the identity of each administrator 50. This verification step may be by password, passcode, or equivalent means. Thus, administrators 50 of the overall system will have the ability to monitor, edit, or delete all user files for appropriateness of content.

As described above, the software application allows a teacher to create a class code for each class that the teacher teaches. Each code will be associated with each of the students who are a member of that class. In one embodiment, this application allows the teacher to use that code to view the portfolios of each student who is a member of the class associated with a particular code entered by the teacher. For instance, a teacher may assign a class of students an assignment and instruct the students to post the assignment to the students' portfolios. Upon completion of the assignment, each student may add the assignment in the form of a computer file to the student's portfolio. The teacher may then view each student's assignment by viewing each of the students' portfolios. The teacher may also show the portfolios to the students' parents in order to demonstrate the progress made by each of the students. One teacher may have multiple codes for each of multiple classes taught by that teacher.

In a preferred embodiment, access to the system is completely private and secure. Incorporating security features currently known in the art may accomplish this. Thus, any information shared by users 48 of the system with administrators 50 of the system will never be transferred to any third parties. Additionally, in a preferred implementation, a user's portfolio will never be shared with other users 48 or third parties unless specifically authorized by the user 48. When the users 48 are students accessing the system with a class code as described above, the code may provide the teacher associated with that code with automatic access to the portfolios. Alternatively, the system may be set up where each student must provide authorization for the teacher to view the student's portfolio.

In addition, a user 48 may choose to make his portfolio available for viewing by any member of the public having access to the internet, or the user may choose to grant access only to individuals of the user's choosing. In an alternative embodiment, a user 48 may grant access only to specific parts of the user's portfolio. For instance, a user may grant access to the entire portfolio to Third Party A, while only granting access to part of the portfolio to Third Party B, and also granting access to a different part of the portfolio to Third Party C. Thus, a user has a great deal of flexibility in granting access to his or her portfolio. A user providing a link to a second user may complete portfolio sharing. In one implementation, a second user may need to provide login credentials to view the first user's portfolio.

In a preferred embodiment, a user 48 will access the Multimedia Portfolio Management server 42 by using an electronic communication device 46, which will access the system through an admin web application interface or similar type of software application. In a preferred implementation, a user 48 will access the admin web page/application via a web browser. The user's electronic communication device 46 may be any computing device such as a laptop 20, personal computer 22, smart phone 24, electronic tablet, PDA, smart digital camera, or similar device.

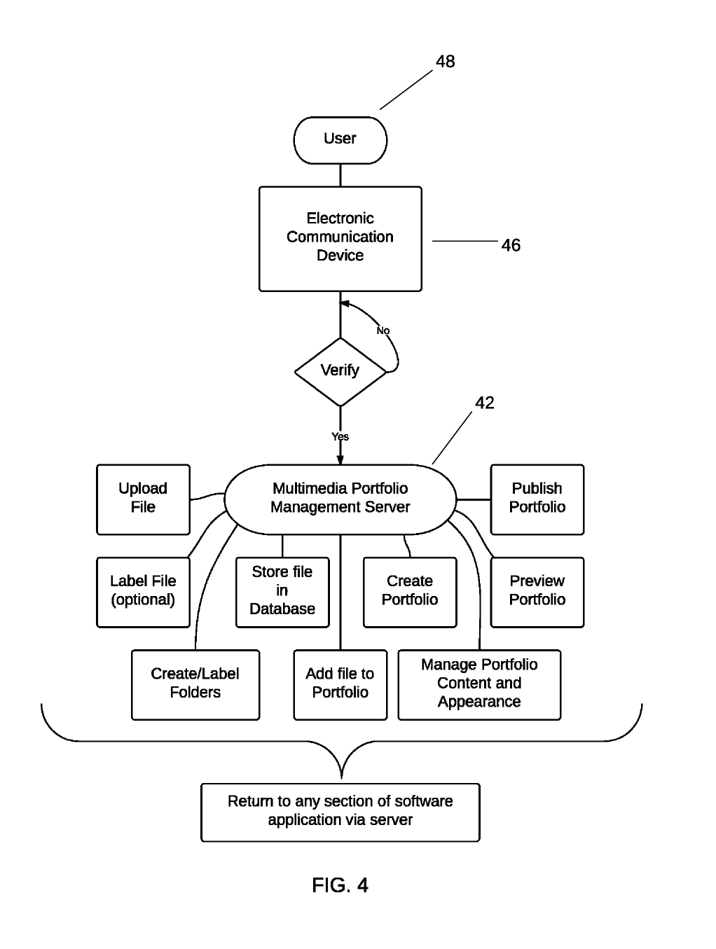

FIG. 4 illustrates a process of using a software application for creating, publishing, and managing a multimedia portfolio. In a preferred embodiment, a user 48 will use an electronic communication device 46 to access the communications network 10 through a web-based software application. Once the user's identity is verified, the user 48 may then use the application to create a multimedia portfolio or engage in other actions related to the management of a portfolio.

For instance, the software application allows a user 48 to upload multimedia files for use in the user's portfolio. Multimedia files that may be utilized with the present invention include, but are not limited to, word processor files, spreadsheet files, digital image files, digital music or other sound files, and digital video files. The application also allows the user to create and label folders stored in the database 44 and then store the files in the user-created folders. The user may then create an electronic portfolio and add the files to the portfolio for viewing. Once a portfolio has been created, the user may preview the portfolio and may also publish the portfolio so that it is viewable by other users. At any time, the application allows the user to change the content and/or appearance of the portfolio. Following any of the above actions taken by the user, the software application will present the user with the option of returning to any section of the application associated with any of the actions illustrated in FIG. 4.

A user 48 of the system interacts with the software application shown in FIG. 4 using some type of electronic communication device 46, e.g., a laptop 20, a personal computer 22, or a smart phone 24, in communication with the network 10. This interaction typically takes place using a web browser, which includes menus and buttons for navigating through the functions of the software application. For instance, the application will have a homepage viewable in the web browser. The homepage may have a dropdown menu listing actions that can be taken, or it may have buttons associated with each of the actions illustrated in FIG. 4. The user may then select a desired action using an input device 36 such as a mouse or a touch screen.

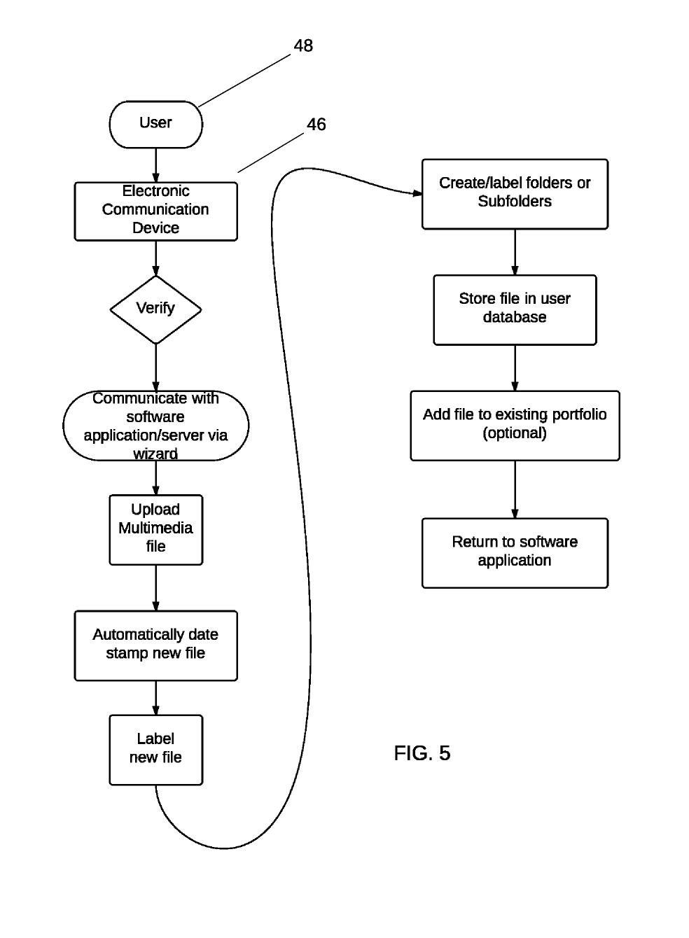

As set forth in FIG. 5, a user 48 will use a web browser to access the admin login webpage. At the admin login webpage a new user will first create a user account within the Multimedia Portfolio Management server 42. In a preferred embodiment, the admin login webpage will include data fields for entering said information and a button/link for submitting said information. A new user will then have the ability to upload multimedia files from a user's electronic communication device 46 to a database 44. In a preferred implementation, the software application does not require the user to be registered with any other service offering storage space for files, but instead can be used directly to upload a user's files to a user database connected to (in communication with) the Multimedia Portfolio Management server 42. The amount of storage space available to the user in the user database may be limited based on the user's account settings.

In a preferred embodiment, all files uploaded through the application will be automatically date stamped. In addition, the user will be presented with an option to label each file with a descriptive label as each file is uploaded to a database 44. The user 48 will then be able to create a new folder within the database 44 or select an existing folder in which to store the uploaded file or files. The user will also have the option of labeling a new or existing folder with a descriptive label. If the user selects the option of labeling either a file or a folder, the application will present data fields to the user for inputting the name the user wishes to assign to the file or the folder.

If the software application is installed on a computing device capable of directly capturing digital images or video, such as a smart phone with a built-in camera or a smart camera, the application may automatically ask the user if the user would like to upload the file to the user's portfolio or to a folder associated with the portfolio immediately after the image or video has been captured. In addition, at the time the image or video is captured, the application may ask the user whether the user wishes to add a unique label to the digital file at that time.

Once a file has been stored in a database 44, a user 48 may then add the file to an existing portfolio. If the user is a new user, he or she will be presented with the option of creating a new portfolio. When creating a new portfolio, the user will be presented with a variety of templates from which to choose. Alternatively, the user may create a customized template using the user's own multimedia files. For instance, a user may choose a digital music file that will play music while the portfolio is being viewed. Alternatively, the user may select an image file that can be used to create a personalized background for the portfolio. The templates will also include the option of inserting text into text boxes viewable as part of the portfolio. In addition, the application allows the user to format and add text to any portion of the portfolio.

Once a portfolio has been created, a user may then use the software application to manage the content and appearance of the portfolio. The user may add or remove multimedia files from the portfolio. The user may also change the appearance of the portfolio by changing the template used for the portfolio or changing the appearance of a customized template. Additionally, the application allows the user to alter the arrangement of multimedia files within the portfolio, preferably by simply dragging an image in the portfolio to a new location. After the portfolio has been customized to the user's liking, the server will then present the user with the option to preview the portfolio before publishing, or to proceed directly to publishing the portfolio so that other users may view the portfolio.

In a preferred embodiment, the multimedia portfolio will be saved in a specific database and accessible via an internet website (e.g., admin website). Each user portfolio published on the internet will be assigned a unique web address. In a preferred embodiment, the software application will present the user with options for sharing the user's portfolio with others. In one embodiment, the user may choose to grant access to the user portfolio to the public, thus allowing any member of the public with access to the internet to view the portfolio. Alternatively, the software application will present the user with options for sharing the portfolio with only individuals designated by the user. The user may share the portfolio with a third party by emailing a link to the portfolio's web address or an invitation to the third party, or by any equivalent means. The user may choose to share the portfolio with other users of the system or with any outside parties. The user may input identifying information, such as an email address, in order to grant access to third parties. Alternatively, a third party may send a request to a user to view the user's portfolio. The application will then present the user with the option of granting or denying the request.

In another embodiment, the software application will present the user with the option of sharing only specific parts of the portfolio with others. The user will be presented with options to restrict a third party's ability to view particular files within the portfolio or alternatively particular sections of the portfolio.

FIG. 5 illustrates a process of uploading, labeling, and storing a multimedia file associated with the user's portfolio via a software wizard. In a preferred embodiment, a user 48 will use a software wizard that will allow the user's electronic communication device 46 to communicate with the software application illustrated in FIG. 4. The software wizard is most advantageous when used to label and store digital image and video files at the time the user captures the digital image or video file. The wizard will allow a user to immediately label and store the file in the user database at the time the user initially captures the image or video. However, use of the wizard is not limited to only image or video files, but may be used to label and store any type of multimedia file. Additionally, the wizard may be used to label and store a file at the time the file is uploaded to a database or at any time subsequent to uploading the file to the database.

In this embodiment, the wizard comprises a user interface that provides the user with step-by-step guidance on labeling and storing a multimedia file. For instance, if a user captures a digital image or video file using a smart phone camera, the wizard will present the user with an option to immediately upload the image to a database 44 for storing files associated with the user. If the user proceeds, the wizard will automatically date stamp the file and present the user with an option to change the label assigned to the file. The wizard will then provide the user with a prompt to choose a folder in the database in which to store the file. At this time, the user will be presented with an option to create and label a new folder or subfolder in the database or to choose an existing folder or subfolder. The user may also be presented with an option to change the name of an existing folder or subfolder in the database. The wizard will then store the file in the chosen location of the database. After storing, the user may then be presented with an option to immediately add the file to an existing portfolio. Once the user has finished using the wizard for labeling and storing files, the wizard will present the user with the option of returning to the software application illustrated in FIG. 4.

In one embodiment of the invention, the wizard may be installed on a mobile phone or a smart digital camera. However, the wizard may be installed on any type of electronic communication device in communication with the network.

It is understood that versions of the invention are embodied in different forms and combinations of software and hardware. Nonetheless, at least two versions of the apparatus are disclosed. One version for Apple iOS operating system, and one version for Google's Android operating system, are disclosed. It is understood that other versions of the invention may be used with different operating systems. It is preferred that the devices used for interfacing with the system have WiFi or cellular internet connectivity.

It will be readily understood to those skilled in the art that various other changes in the details, material, and arrangements of the parts and method stages which have been described and illustrated in order to explain the nature of this inventive subject matter can be made without departing from the principles and scope of the inventive subject matter.

I claim:

1. An electronic portfolio management system, comprising:
a. a plurality of computing devices each having computer executable code thereon, said code configured for creating and managing an electronic portfolio comprising a plurality of multimedia computer files;
b. a portfolio management server in electronic communication with said plurality of computing devices via an electronic communications network;
c. at least one user database in electronic communication with said portfolio management server, said at least one user database storing a plurality of multimedia computer files, each file associated with a particular user; and
d. said computer executable code comprising a means for each user to upload multimedia computer files to said at least one database, a means for each user to label multimedia files, a means for each user to store multimedia files in a user-selected folder stored in said database, a means for each user to create an electronic portfolio comprising said multimedia files associated with said user, and a means for each user to control access to said electronic portfolio by other users accessing said portfolio via other computing devices in communication with said portfolio management server.

2. The electronic portfolio management system of claim 1, wherein said computer executable code further comprises a means for each user to create and label folders and subfolders within said at least one database for storing multimedia files.

3. The electronic portfolio management system of claim 1, wherein said computer executable code further comprises a means for each user to access said server by inputting a code and user-identifying information.

4. The electronic portfolio management system of claim 1, wherein said computer executable code further comprises a means for each user to preview a portfolio and to publish a portfolio for other users to view.

5. The electronic portfolio management system of claim 1, wherein said means for controlling access to said portfolio comprises a means for restricting viewing by user-selected viewers to user-selected portions of said portfolio.

6. The electronic portfolio management system of claim 1, wherein said computer executable code provides a plurality of portfolio templates from which a user may select a portfolio template.

7. A computer-implemented method for creating and managing electronic portfolios, said method comprising the steps of:
a. identifying a plurality of users;
b. establishing an account for each of said users, each account associated with at least one electronic portfolio for said user of said account;
c. providing a plurality of computing devices that communicates with each of said users, each computing device having computer executable code thereon, said code configured for creating and managing said at least one electronic portfolio, each portfolio comprising a plurality of multimedia computer files;
d. providing at least one portfolio management server in electronic communication with each of the plurality of computing devices, each server being in electronic communication with at least one database, each server configured to host a plurality of electronic portfolios, one or more of said portfolios associated with a particular user, and each server configured to allow a user to associate one or more multimedia computer files with one or more electronic portfolios associated with said user;
e. allowing each of said users to create one or more electronic portfolios using one of said plurality of computing devices by allowing the user to upload one or more multimedia computer files to said at least one database, providing an option to label each of said multimedia files, allowing the user to select a storage location of each multimedia file in user-created folders stored in said at least one database, and allowing the user to add said multimedia files to said electronic portfolio; and
f. allowing each of said users to control access to said electronic portfolio by other users accessing said portfolio via other computing devices in communication with said portfolio management server.

8. The method of claim 7, further comprising the step of verifying the identity of each of said plurality of users.

9. The method of claim 8, wherein the identity of each of said plurality of users is identified by each user inputting a code and user-identifying information.

10. The method of claim 7, further comprising the step of automatically date stamping computer files uploaded to said at least one database.

11. The method of claim 7, further comprising the step of allowing each of said users to preview a portfolio and to publish a portfolio for other users to view.

12. The method of claim 7, wherein the step of allowing each of said users to control access to said electronic portfolio by other users further comprises allowing a user to restrict viewing by user-selected viewers to user-selected portions of said portfolio.

13. The method of claim 7, wherein said computer executable code provides a plurality of portfolio templates from which a user may select a portfolio template.

14. A non-transient computer-readable medium containing program instructions configured for causing a computer system to perform a method comprising:
a. establishing an account for each of a plurality of users, each account associated with at least one electronic portfolio for said user of said account;
b. verifying the identity of each of said users;
c. allowing each of said users to upload one or more multimedia computer files to at least one database;
d. allowing each of said users to label each of said multimedia files;
e. allowing each of said users to select a storage location of each multimedia file in user-created folders stored in said at least one database;
f. allowing each of said users to create one or more electronic portfolios comprising one or more of said multimedia files; and
g. allowing each of said users to control access to said electronic portfolio by other users.

15. The computer-readable medium of claim 14, wherein the computer system further performs the step of verifying the identity of each of said plurality of users.

16. The computer-readable medium of claim 15, wherein the identity of each of said plurality of users is identified by each user inputting a code and user-identifying information.

17. The computer-readable medium of claim 14, wherein the computer system further performs the step of automatically date stamping computer files uploaded to said at least one database.

18. The computer-readable medium of claim 14, wherein the computer system further performs the step of allowing each of said users to preview a portfolio and to publish a portfolio for other users to view.

19. The computer-readable medium of claim 14, wherein the step of allowing each of said users to control access to said electronic portfolio by other users further comprises allowing a user to restrict viewing by user-selected viewers to user-selected portions of said portfolio.

20. The computer-readable medium of claim 14, wherein the computer system further performs the step of providing a plurality of portfolio templates from which a user may select a portfolio template.
